(19) United States
(12) Patent Application Publication
(10) Pub. No.: US 2025/0383875 A1
(43) Pub. Date: Dec. 18, 2025

(54) PROCESSOR, INFORMATION PROCESSING APPARATUS, AND METHOD FOR CONTROLLING PROCESSOR

(71) Applicant: Fujitsu Limited, Kawasaki-shi (JP)

(72) Inventor: Ryohei OKAZAKI, Kawasaki (JP)

(73) Assignee: Fujitsu Limited, Kawasaki-shi (JP)

(21) Appl. No.: 19/230,617

(22) Filed: Jun. 6, 2025

(30) Foreign Application Priority Data
Jun. 12, 2024 (JP) 2024-095190

(51) Int. Cl. G06F 9/38

(52) U.S. Cl. CPC G06F 9/3806; G06F 9/3861; G06F 9/3867

(57) ABSTRACT

A branch instruction processing unit determines whether a branch has been taken in response to a predetermined branch instruction, detects a branch misprediction, and completes the predetermined branch instruction. A prediction TAGE table RAM stores a prediction TAGE table that is used in branch prediction for fetch. An updating TAGE table RAM stores an updating TAGE table in which information that is similar to information of the prediction TAGE table is registered. In a case where writing for updating is not being performed on the updating TAGE table, an updating determination circuit receives notification of completion information relating to a predetermined branch instruction, acquires information relating to the predetermined branch instruction from the updating TAGE table, and determines whether updating will be performed. In a case where it has been determined that updating will be performed, the updating determination circuit updates the prediction TAGE table and the updating TAGE table.

### CROSS-REFERENCE TO RELATED APPLICATION

This application is based upon and claims the benefit of priority of the prior Japanese Patent Application No. 2024-095190, filed on Jun. 12, 2024, the entire contents of which are incorporated herein by reference.

### FIELD

The embodiment discussed herein is related to a processor, an information processing apparatus, and a method for controlling the processor.

### BACKGROUND

As a branch prediction mechanism having high prediction accuracy, a tagged geometric history length branch prediction (TAGE) branch prediction mechanism is widely known. The TAGE branch predictor has table TO (referred to as a bimodal table) using a program counter (PC) as an index. The TAGE branch predictor also has a plurality of tables using, as an index, the exclusive OR of the program counter and a global history register (GHR). For example, the TAGE branch predictor has tables T1 to T4 as the plurality of tables using, as an index, the exclusive OR of the program counter and the GHR. Tables T1 to T4 geometrically increase in a GHR length in the order of table T1, table T2, table T3, and table T4. For example, tables T1 to T4 increase in the GHR length in this order to have GHR lengths of 2, 4, 8, and 16, respectively.

The TAGE branch predictor uses a folded GHR in a case where the GHR length is greater than an index length of a table. Furthermore, each of tables T1 to T4 has a tag, Pred, and a useful bit. Pred is a counter that increases or decreases according to a result of determining whether the branch is taken or not taken, and positive/negative determination is used to determine whether the branch is taken or not taken.

In prediction, the TAGE branch predictor searches each of tables T0 to T4. Then, the TAGE branch predictor employs a result having a longest GHR length as a prediction from among results for which a tag matches (TAG-MATCH) among T1 to T4.

In updating a table, the TAGE branch predictor performs updating according to an algorithm of TAGE. The useful bit indicates a degree of usefulness of each entry, and an entry for which the useful bit has a value of 0 is determined to be overwritable. In the case of a misprediction, the TAGE branch predictor overwrites an entry for which a value of useful is 0 to generate an entry. Furthermore, the TAGE branch predictor updates Pred of an entry used in the prediction in accordance with an actual result of determining whether the branch has been taken or has not been taken.

Here, in a case where TAGE branch prediction is implemented in a superscalar processor that operates out of order, and is pipelined, branch prediction is normally executed in a pipeline stage near instruction fetch. On the other hand, the updating of a table is performed after whether the branch is taken or not taken has been confirmed for a branch instruction, and is a pipeline stage of completion of the branch instruction. Therefore, the updating of the table is performed in the latter half of the pipeline stage in many cases.

Furthermore, in TAGE branch prediction, in updating processing, a table is once read before updating, and it is determined whether a counter will be updated. In updating, the table is also read to write the counter or the like. Then, a pipeline stage near instruction fetch is separated from a pipeline stage of completion of a branch instruction, and therefore the TAGE branch predictor has two independent systems, a reading port for prediction and a reading port for updating. Furthermore, in order to perform branch prediction in parallel to writing a result of reading, the TAGE branch predictor generally performs reading and writing simultaneously.

Furthermore, a TAGE branch prediction mechanism is generally improved in prediction accuracy by increasing the number of entries, and therefore the TAGE branch prediction mechanism is implemented by using an SRAM excellent in area efficiency in many cases. Accordingly, conventionally, in a case where the TAGE branch prediction mechanism is implemented, a RAM that can deal with 2-read 1-write and simultaneous read/write is generally used. 2-read 1-write is a function of performing reading in two independent systems, and performing writing in one system. Furthermore, simultaneous read/write is a function of simultaneously performing reading and writing.

As an example of a technique of the TAGE branch prediction mechanism, a technique of determining a level of reliability of branch prediction by adding weighted values or normalized values of a TAGE alternative count, a provider count, and a bimodal count, and comparing a result with a threshold has been proposed.
Patent Document 1: Japanese National Publication of International Patent Application No. 2023-540036

### SUMMARY

According to an aspect of an embodiment, a processor includes a pipeline in which an instruction is fetched and executed, a branch instruction processing unit that determines whether a branch has been taken in response to a predetermined branch instruction in execution of the instruction in the pipeline, detects a branch misprediction, and completes the predetermined branch instruction, a first storage that stores a first table, information relating to a branch instruction being registered in the first table, the first table being used in branch prediction for fetch, a second storage that stores a second table, information relating to the branch instruction that is similar to the information of the first table being registered in the second table, and an updating determination circuit that, in a case where writing for updating is not being performed on the second table, receives, from the branch instruction processing unit, notification of completion information relating to the predetermined branch instruction, acquires information relating to the predetermined branch instruction from the second table, determines whether the updating will be performed, and updates the first table and the second table in a case where it has been determined that the updating will be performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a system according to an embodiment;

FIG. 2 is a diagram illustrating a configuration example of a superscalar processor according to the embodiment;

FIG. 3 is a block diagram of a branch prediction mechanism;

FIG. 4 is a flowchart of processing of notification of completion information relating to a completed branch instruction; and

FIG. 5 is a flowchart of TAGE table updating processing.

### DESCRIPTION OF EMBODIMENT

However, in general, the RAM that can deal with 2-read 1-write and simultaneous read/write is likely to increase in an area, and the area increases about twice in comparison with a RAM that deals with 1-read 1-write, and does not deal with simultaneous read/write in some cases. An increase in the area of a RAM causes an increase in wiring length for transmitting a signal to be used in prediction, and this causes a problem of an increase in latency of prediction. Furthermore, in a technique of predicting the level of reliability of branch prediction from the TAGE alternative count and the like, no special consideration is given to a RAM to be used, and it is difficult to prevent latency from increasing due to an increase in the area of a RAM.

Preferred embodiments will be explained with reference to accompanying drawings. Note that the embodiment described below is not restrictive of the processor, the information processing apparatus, and the method for controlling the processor that are disclosed herein.

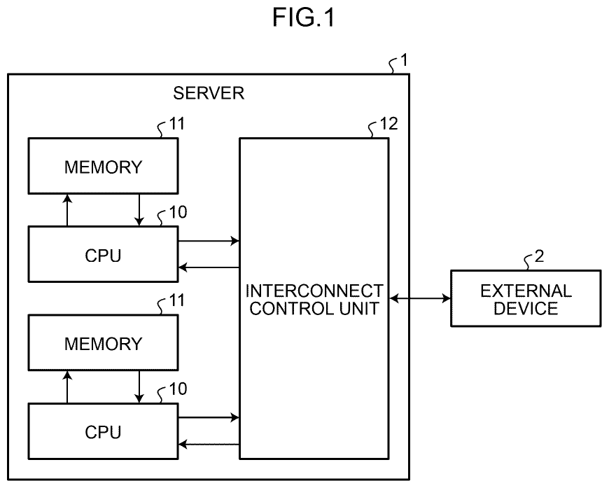

FIG. 1 is a diagram illustrating a configuration example of a system according to an embodiment. The system according to the present embodiment is, for example, an information processing apparatus such as a server 1 illustrated in FIG. 1.

The server 1 is an information processing apparatus that includes a plurality of central processing units (CPUs) 10, a plurality of memories 11, and an interconnect control unit 12.

The interconnect control unit 12 relays communication of the CPUs 10. For example, the interconnect control unit 12 relays communication between the CPUs 10. The interconnect control unit 12 also relays communication between each of the CPUs 10 and an external device 2.

The memories 11 are principal storage devices. The memories 11 are, for example, dynamic random access memories (DRAMs).

The respective CPUs 10 are connected to the memories 11 different from each other. Furthermore, each of the CPUs 10 is connected to the interconnect control unit 12. These CPUs 10 are an example of a “processor”.

The CPU 10 performs communication with another CPU 10 or the external device 2 via the interconnect control unit 12. The CPU 10 also executes various programs such as an operating system (OS) by using the memory 11.

The CPU 10 according to the present embodiment performs pipeline processing to execute a program. Moreover, the CPU 10 performs TAGE branch prediction on a branch instruction, and executes a program. In a case where a branch misprediction has occurred, the CPU 10 refetches an instruction out of order to continue processing from an address of a correct branch instruction. An example of details of the CPU 10 will be described below.

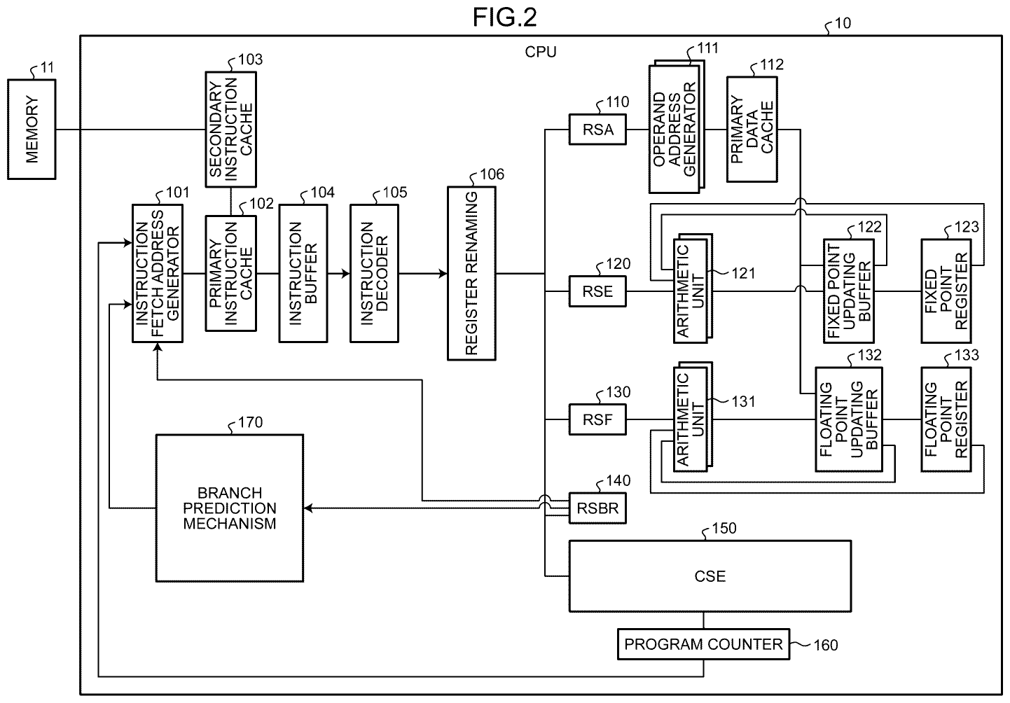

FIG. 2 is a diagram illustrating a configuration example of a superscalar processor according to the embodiment. Here, description is provided by using, as an example, a case where the CPU 10 is a superscalar processor that performs plural pieces of pipeline processing in parallel. However, FIG. 2 is an example of the CPU 10, and the CPU 10 may be a processor having another configuration.

The CPU 10 includes an instruction fetch address generator 101, a primary instruction cache 102, a secondary instruction cache 103, an instruction buffer 104, an instruction decoder 105, and register renaming 106, as illustrated in FIG. 2. The CPU 10 further includes a reservation station for address generation (RSA) 110, an operand address generator 111, and a primary data cache 112. Furthermore, the CPU 10 includes a reservation station for execution (RSE) 120, an arithmetic unit 121, a fixed point updating buffer 122, a reservation station for floating point (RSF) 130, an arithmetic unit 131, and a floating point updating buffer 132. The CPU 10 further includes a reservation station for branch (RSBR) 140, a commit stack entry (CSE) 150, a program counter (PC) 160, and a branch prediction mechanism 170.

A mechanism excluding the secondary instruction cache 103 in the CPU 10 is referred to as a core in some cases. Respective reservation stations, such as the RSA 110, the RSE 120, the RSF 130, and the RSBR 140, are mechanisms that hold an instruction until the instruction becomes executable. Each of the RSA 110, the RSE 120, the RSF 130, and the RSBR 140 has a queue.

The instruction fetch address generator 101, the instruction buffer 104, and the instruction decoder 105 correspond to a pipeline of instruction execution. Furthermore, the instruction fetch address generator 101 and the instruction buffer 104 correspond to an instruction fetch mechanism.

The instruction fetch address generator 101 receives, from the program counter 160, an input of a fetch address of an instruction according to the order of programs. The instruction fetch address generator 101 also receives an input of a prediction result of branch prediction performed by the branch prediction mechanism 170.

In a case where a result of branch prediction performed by the branch prediction mechanism 170 indicates that the branch is not taken, the instruction fetch address generator 101 processes an instruction in order of earliest acquisition from the program counter 160. In a case where a result of branch prediction performed by the branch prediction mechanism 170 indicates that the branch is taken, the instruction fetch address generator 101 generates a fetch address of a branch destination. Then, the instruction fetch address generator 101 processes an instruction of the generated fetch address. Furthermore, the instruction fetch address generator 101 outputs the generated fetch address to the branch prediction mechanism 170. Then, the instruction fetch address generator 101 continues to process instructions that follow the instruction in order of earliest acquisition from the program counter 160.

The instruction fetch address generator 101 processes each of the instructions as described below. In a case where a cache hit has occurred in the primary instruction cache 102 for an instruction of the generated fetch address, the instruction fetch address generator 101 causes an instruction held by the primary instruction cache 102 to be stored in the instruction buffer 104. In contrast, in a case where a cache miss has occurred in the primary instruction cache 102, the instruction fetch address generator 101 searches the secondary instruction cache 103 for a target instruction. In a case where a cache hit has occurred in the secondary instruction cache 103, the instruction fetch address generator 101 causes an instruction held by the secondary instruction cache 103 to be stored in the primary instruction cache 102, and causes the instruction to be stored in the instruction buffer 104. In a case where a cache miss has occurred in the secondary instruction cache 103, the instruction fetch address generator 101 acquires an instruction from the memory 11. Then, the instruction fetch address generator 101 causes an instruction held by the secondary instruction cache 103 to be stored in the primary instruction cache 102, and causes the instruction to be stored in the instruction buffer 104.

The instruction buffer 104 is a buffer that stores instruction sequences to be executed in the future. The instruction buffer 104 stores a maximum capacity of instructions regardless of a state of instruction execution. Furthermore, the instruction buffer 104 can output a held instruction regardless of a state of instruction fetch. The instruction buffer 104 separates instruction fetch from instruction execution to conceal latency due to instruction execution or instruction fetch.

The instruction decoder 105 acquires instructions stored in the instruction buffer 104 in the order of processing. Then, the instruction decoder 105 decodes the acquired instruction. Then, the instruction decoder 105 outputs the decoded instruction to the register renaming 106.

The register renaming 106 is a buffer that temporarily holds an instruction after the execution of the instruction is committed (confirmed) and before the instruction is stored in a register. The register renaming 106 receives an input of the decoded instruction from the instruction decoder 105. Next, the register renaming 106 determines a resource to be used to execute the instruction from among the RSA 110, the RSE 120, the RSF 130, and the RSBR 140. Then, the register renaming 106 determines whether the determined resource has a vacancy. In a case where the determined resource has a vacancy, the register renaming 106 allocates the determined resource to the decoded instruction. Then, the register renaming 106 allocates an identifier to the decoded instruction, and issues the instruction to any allocated resource of the RSA 110, the RSE 120, the RSF 130, and the RSBR 140.

Furthermore, the register renaming 106 sequentially allocates an instruction identification (IID) to each of the decoded instructions. Then, the register renaming 106 transmits the instructions to the CSE 150 in order of the allocated instruction identifications.

The RSA 110 is a reservation station for calculation of an address of a load/store instruction. The load/store instruction is either a load instruction or a store instruction. The RSA 110 holds an instruction acquired from the instruction decoder 105 until the operand address generator 111 becomes able to perform processing. When the operand address generator 111 has become able to perform processing, the RSA 110 outputs the instruction to the operand address generator 111. The RSA 110 executes the load/store instruction out of order. Then, when the execution of the load/store instruction has been completed, the RSA 110 reports the termination of an execution instruction to the CSE 150.

There is a plurality of operand address generators 111. The operand address generator 111 receives an input of the load/store instruction from the RSA 110. Then, the operand address generator 111 generates an operand for address calculation, and executes address calculation by using the generated address to generate an address that corresponds to the instruction. Then, the operand address generator 111 waits for store data, and writes the data to the primary data cache 112, by using the generated address.

The RSE 120 is a reservation station for integer arithmetic. The RSE 120 holds an instruction acquired from the instruction decoder 105 until the arithmetic unit 121 becomes able to perform arithmetic processing. When the arithmetic unit 121 has become able to perform arithmetic processing, the RSE 120 outputs the instruction to the arithmetic unit 121. The RSE 120 executes the instruction out of order. Then, when the execution of an arithmetic instruction has been completed, the RSE 120 reports the termination of an execution instruction to the CSE 150.

There is a plurality of arithmetic units 121. The arithmetic unit 121 executes fixed point arithmetic by using the fixed point updating buffer 122 and a fixed point register 123. After the arithmetic has been completed, result data is written to the fixed point updating buffer 122. Then, when calculation data has been committed, the committed calculation data is transmitted to the fixed point register 123.

The RSF 130 is a reservation station for floating point arithmetic. The RSF 130 holds an instruction acquired from the instruction decoder 105 until the arithmetic unit 131 becomes able to perform arithmetic processing. When the arithmetic unit 131 has become able to perform arithmetic processing, the RSF 130 outputs the instruction to the arithmetic unit 131. The RSF 130 executes the instruction out of order. Then, when the execution of an arithmetic instruction has been completed, the RSF 130 reports the termination of an execution instruction to the CSE 150.

There is a plurality of arithmetic units 131. The arithmetic unit 131 executes floating point arithmetic by using the floating point updating buffer 132 and a floating point register 133. After the arithmetic has been completed, result data is written to the floating point updating buffer 132. Then, when calculation data has been committed, the committed calculation data is transmitted to the floating point register 133.

The CSE 150 is a circuit that performs commit processing. The CSE 150 has a queue that holds decoded instructions in order of execution of the instructions. The CSE 150 stores and accumulates instructions received from the register renaming 106 in the queue in order of execution. Then, the CSE 150 waits for a report on the completion of processing on an instruction in a state where the instructions are stored in the queue.

The CSE 150 receives, out of order, a termination report of each of the executed instructions from the RSA 110, the RSE 120, and the RSF 130. Furthermore, the CSE 150 receives, in order, a signal of the completion of processing on a branch instruction from the RSBR 140.

Then, the CSE 150 reorders instructions that are accumulated in the queue and for which a termination report is waited for, in order of execution. Then, when the CSE 150 has received a report using a signal of the completion of processing, the CSE 150 commits an instruction for which a notification of the completion of processing has been received from among the instructions stored in the queue, and updates a resource.

The RSBR 140 is a reservation station for a branch instruction. The RSBR 140 receives an input of the branch instruction from the instruction decoder 105. Then, the RSBR 140 stores the branch instruction in an RSBR queue that the RSBR 140 has. The RSBR queue is a queue that operates according to the first-in first-out (FIFO) method. Each entry of the RSBR queue holds a prediction result indicating that the branch is taken or not taken in branch prediction, or a predicted address.

The RSBR 140 receives an arithmetic result of the arithmetic unit 121 or 131 from the arithmetic unit 121 or 131. Then, the RSBR 140 determines which of taken and not-taken has occurred in a branch instruction, from the arithmetic result acquired for each of the entries. For example, in a case where the CPU 10 is an ARM-based processor, the RSBR 140 acquires a value that has been stored in an NZCV register, and is based on an arithmetic result of an NZCV confirmation instruction, and performs determination. Furthermore, the RSBR 140 confirms a target address of an instruction stored for each of the entries.

The RSBR 140 normally processes, in order, branch instructions stored in an RSBR queue. Stated another way, the RSBR 140 sequentially processes instructions stored in the RSBR queue in order of storage. However, the RSBR 140 outputs, out of order, instruction refetch requests in a case where a branch misprediction has occurred.

The RSBR 140 determines whether a branch misprediction has occurred in each of the branch instructions, by using a result of determination of the branch of each of the entries. In a case where the RSBR 140 has determined that a branch misprediction has occurred, the RSBR 140 determines instruction refetch for a corresponding branch instruction. Then, the RSBR 140 outputs an instruction refetch request to the instruction fetch address generator 101, and causes the instruction fetch address generator 101 to perform instruction refetch. Moreover, the RSBR 140 clears instructions before decoding in a pipeline, and clears the pipeline.

Then, the RSBR 140 completes, in order, branch instructions for which it has been determined whether a branch misprediction has occurred. Then, the RSBR 140 outputs, to the branch prediction mechanism 170, a completion report and completion information for the completed branch instruction. However, in a case where an instruction to inhibit a branch instruction from being completed has been received from the branch prediction mechanism 170, the RSBR 140 stops processing for completing the branch instruction until a notification of releasing inhibition is received. Here, the completion information includes information indicating taken or not-taken for a completed branch instruction. The RSBR 140 described above is an example of a “branch instruction processing unit”.

The branch prediction mechanism 170 executes TAGE branch prediction. Then, the branch prediction mechanism 170 outputs, to the instruction fetch address generator 101, a prediction result of TAGE branch prediction that indicates taken or not-taken.

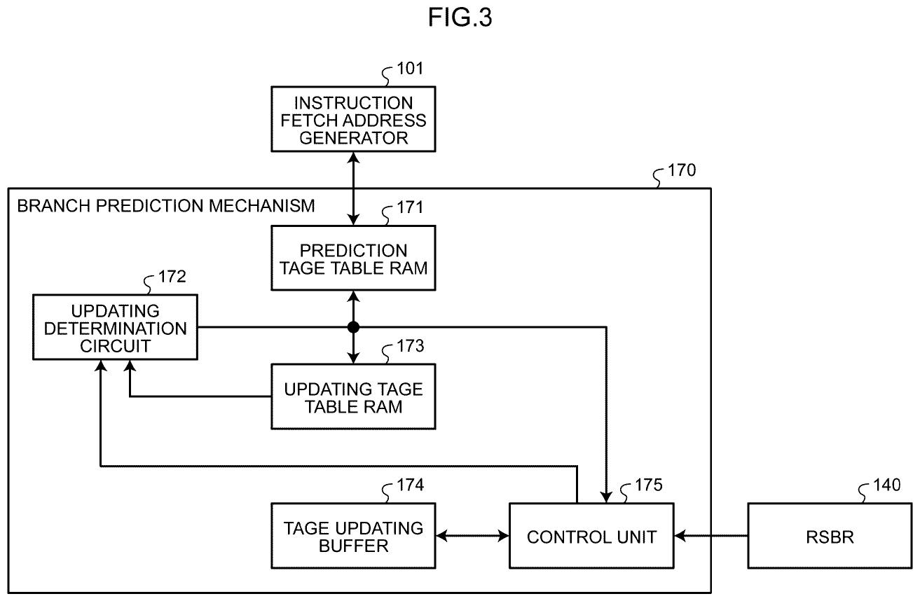

FIG. 3 is a block diagram of the branch prediction mechanism. Details of an operation of the branch prediction mechanism 170 will be described below with reference to FIG. 3. The branch prediction mechanism 170 includes a prediction TAGE table random access memory (RAM) 171, an updating determination circuit 172, an updating TAGE table RAM 173, a TAGE updating buffer 174, and a control unit 175.

The prediction TAGE table RAM 171 holds a prediction TAGE table that is used for TAGE branch prediction performed by the branch prediction mechanism 170. In the prediction TAGE table, information relating to a branch instruction, such as completion information, is registered. The prediction TAGE table RAM 171 is disposed near an instruction fetch mechanism such as the instruction fetch address generator 101. The prediction TAGE table RAM 171 is a RAM that deals with 1-read 1-write, and does not deal with simultaneous read/write.

The updating TAGE table RAM 173 holds an updating TAGE table that is used to determine updating of a TAGE table. The updating TAGE table is a table that is used to determine whether the updating TAGE table will be updated, and information relating to a branch instruction that is similar to the information of the prediction TAGE table is registered in the updating TAGE table. The updating TAGE table RAM 173 is disposed near a place where the completion of a branch instruction is processed. For example, the updating TAGE table RAM 173 is disposed near the RSBR 140. The updating TAGE table RAM 173 is also a RAM that deals with 1-read 1-write, and does not deal with simultaneous read/write. Hereinafter, the prediction TAGE table and the updating TAGE table are collectively and simply referred to as “TAGE tables” in some cases.

Here, the prediction TAGE table is an example of a “first table”. Furthermore, the prediction TAGE table RAM 171 is an example of a “first storage unit”. The updating TAGE table is an example of a “second table”. Moreover, the updating TAGE table RAM 173 is an example of a “second storage unit”.

The control unit 175 receives, from the RSBR 140, an input of a completion report and completion information for a completed branch instruction. Upon receipt of the completion report, the control unit 175 generates an entry of the completed branch instruction in the TAGE updating buffer 174. Here, in a case where the TAGE updating buffer 174 has no space needed to generate an entry, the control unit 175 inhibits the RSBR 140 from completing a branch instruction. The control unit 175 registers, in the generated entry, information that relates to a branch instruction for which a completion report has been received, and includes completion information of the branch instruction. Then, when a vacancy has been generated in the TAGE updating buffer 174, the control unit 175 notifies the RSBR 140 of the release of inhibition of completion of a branch instruction.

Furthermore, in order to read, in order, completion information relating to a branch instruction for which an entry has been generated in the TAGE updating buffer 174, the control unit 175 gives an out-pointer in such a way that the out-point indicates an entry of an instruction to be read next. The TAGE updating buffer 174 described above is an example of a “temporary storage unit”. Stated another way, the control unit 175 receives, from the RSBR 140, notification of a predetermined branch instruction, and stores completion information relating to the predetermined branch instruction in the TAGE updating buffer 174 serving as the temporary storage unit.

Then, the control unit 175 reads completion information relating to a branch instruction from the TAGE updating buffer 174 in order to cause the updating determination circuit 172 to determine the updating of a TAGE table. Here, in reading the completion information relating to a branch instruction from the TAGE updating buffer 174, the control unit 175 determines whether an instruction to inhibit reading a branch prediction from the TAGE updating buffer 174 has been received from the updating determination circuit 172. In a case where an instruction to inhibit reading of branch prediction has been received, the control unit 175 inhibits reading completion information of branch prediction, until an instruction to release inhibition of reading of branch prediction is received from the updating determination circuit 172.

If an instruction to inhibit reading of a branch prediction has not been received, or if notification of the release of inhibition of reading a branch prediction has been received, the control unit 175 reads a branch instruction from an entry indicated by the out-pointer. Moreover, the control unit 175 determines whether the updating determination circuit 172 is performing writing to the updating TAGE table RAM 173, at a timing when the control unit 175 has read the branch instruction.

In a case where the updating determination circuit 172 is not performing writing to the updating TAGE table RAM 173, the control unit 175 performs the processing described below. The control unit 175 determines that the reading performed by the updating determination circuit 172 of an updating TAGE table from the updating TAGE table RAM 173 for determination of updating does not conflict with the writing performed by the updating determination circuit 172 to the updating TAGE table RAM 173 for updating of the updating TAGE table. Then, the control unit 175 notifies the updating determination circuit 172 of completion information relating to a branch instruction read from the TAGE updating buffer 174. Moreover, the control unit 175 deletes an entry of the read branch instruction from the updating TAGE table RAM 173, and updates the out-pointer in such a way that the out-pointer indicates an entry of a branch instruction to be read next.

In contrast, in a case where it has been determined that the updating determination circuit 172 is performing writing to the updating TAGE table RAM 173, the control unit 175 performs the processing described below. The control unit 175 determines that the reading performed by the updating determination circuit 172 of an updating TAGE table from the updating TAGE table RAM 173 for determination of updating conflicts with the writing performed by the updating determination circuit 172 to the updating TAGE table RAM 173 for updating of the updating TAGE table. In this case, the control unit 175 cancels notifying the updating determination circuit 172 of completion information relating to a branch instruction read from the TAGE updating buffer 174. Then, the control unit 175 keeps an out-pointer indicating the read entry. As described above, by not updating the out-pointer, the control unit 175 can process a branch instruction that has been read but for which updating has not been determined, again in the next order.

It can be said that the keeping of an out-pointer indicating a read entry without notifying the updating determination circuit 172 of completion information relating to a branch instruction that has been read from the TAGE updating buffer 174 is processing of treating the branch instruction as not having been read from the TAGE updating buffer 174. Accordingly, hereinafter, processing of keeping an out-pointer indicating a read entry without notifying the updating determination circuit 172 of completion information relating to a branch instruction read from the TAGE updating buffer 174 is referred to as “cancellation of reading a branch instruction”.

As described above, the control unit 175 reads completion information relating to a predetermined branch instruction from the TAGE updating buffer 174 serving as the temporary storage unit, and determines whether writing for updating is being performed on the updating TAGE table serving as the second table. In a case where writing for updating is not being performed on the updating TAGE table, the control unit 175 notifies the updating determination circuit 172 of completion information relating to the predetermined branch instruction.

The updating determination circuit 172 receives, from the control unit 175, notification of completion information relating to a branch instruction read from the TAGE updating buffer 174. Then, the updating determination circuit 172 reads a branch instruction indicated by the completion information of the notification, from the updating TAGE table that is stored in the updating TAGE table RAM 173. Then, the updating determination circuit 172 determines whether a TAGE table will be updated, by using information relating to the updating TAGE table and the completion information.

In a case where the TAGE table will be updated, the updating determination circuit 172 updates both the updating TAGE table that is held by the updating TAGE table RAM 173, and the prediction TAGE table that is held by the prediction TAGE table RAM 171. For example, the updating determination circuit 172 updates Pred serving as a counter that counts a branch result in the updating TAGE table and the prediction TAGE table, in accordance with a result of determination of taken or not-taken. Furthermore, the updating determination circuit 172 updates Useful of the updating TAGE table and the prediction TAGE table, in accordance with a result of determining whether a branch misprediction has occurred.

As described above, in a case where the updating determination circuit 172 is not performing writing for updating on the updating TAGE table, the updating determination circuit 172 receives, from the control unit 175, notification of completion information that has been transmitted from the RSBR 140. Stated another way, in a case where the updating determination circuit 172 is not performing writing for updating on the second table, the updating determination circuit 172 receives notification of completion information that relates to a predetermined branch instruction and has been transmitted from the RSBR 140. Then, the updating determination circuit 172 acquires information relating to the predetermined branch instruction from the second table, and determines whether updating will be performed. In a case where it has been determined that updating will be performed, the updating determination circuit 172 updates the first table and the second table.

In updating the TAGE table, the updating determination circuit 172 provides the control unit 175 with an instruction to inhibit reading a branch prediction from the TAGE updating buffer 174. The updating determination circuit 172 also notifies the instruction fetch address generator 101 of inhibition of instruction fetch. Then, when writing has been completed, the control unit 175 is notified of the release of inhibition of reading a branch prediction from the TAGE updating buffer 174, and the instruction fetch address generator 101 is notified of the release of inhibition of instruction fetch. As described above, in a case where the updating determination circuit 172 has determined that the TAGE table will be updated, the updating determination circuit 172 inhibits the control unit 175 from reading information from the TAGE updating buffer 174 serving as the temporary storage unit.

As described above, in a case where the updating determination circuits 172 is performing writing to the updating TAGE table RAM 173 in order to update the TAGE table, the control unit 175 does not notify the updating determination circuit 172 of completion information of branch prediction. Furthermore, in updating the updating TAGE table, the updating determination circuit 172 inhibits reading from the TAGE updating buffer 174. Therefore, by taking such double measures, the updating determination circuit 172 can perform writing to the updating TAGE table RAM 173 for updating in preference to reading from the updating TAGE table RAM 173 for determination of updating. Furthermore, in updating the prediction TAGE table, the updating determination circuit 172 inhibits instruction fetch, and gives priority to writing by updating the TAGE table. Accordingly, a RAM that deals with 1-read 1-write but does not deal with simultaneous read/write can be used for both the prediction TAGE table RAM 171 and the updating TAGE table RAM 173.

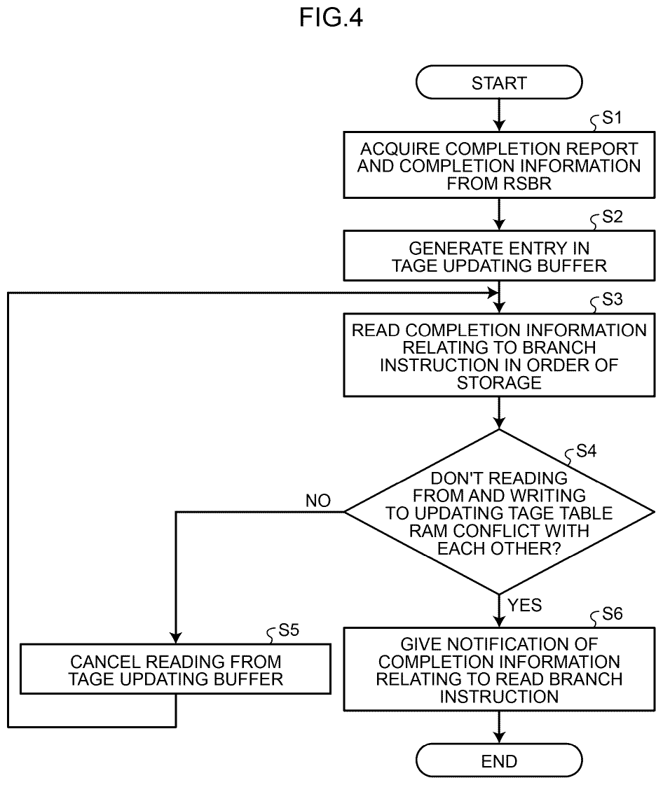

FIG. 4 is a flowchart of processing of notification of completion information relating to a completed branch instruction. Next, a flow of processing performed by the control unit 175 for giving notification of completion information relating to a completed branch instruction will be described with reference to FIG. 4.

The control unit 175 acquires, from the RSBR 140, a completion report and completion information for a completed branch instruction (Step S1).

Next, the control unit 175 generates an entry of the branch instruction for which the completion report has been acquired in the TAGE updating buffer 174 (Step S2). The control unit 175 registers, in the generated entry, the completion information or the like of the branch instruction for which the completion report has been received.

Then, the control unit 175 reads completion information relating to a branch instruction from the TAGE updating buffer 174 in order of storage (Step S3).

Next, the control unit 175 determines whether the updating determination circuit 172 is not performing writing for updating on the updating TAGE table RAM 173, at a timing when the branch instruction has been read. By doing this, the control unit 175 determines whether reading from and writing to the updating TAGE table RAM 173 do not conflict with each other (Step S4).

In a case where reading from and writing to the updating TAGE table RAM 173 conflict with each other (Step S4: positive), the control unit 175 does not notify the updating determination circuit 172 of completion information relating to a branch instruction that has been read from the TAGE updating buffer 174. Then, the control unit 175 does not update the out-pointer in the TAGE updating buffer 174, and cancels reading of information relating to the branch instruction from the TAGE updating buffer 174 (Step S5). Then, the processing of the control unit 175 returns to Step S3.

In contrast, in a case where reading from and writing to the updating TAGE table RAM 173 do not conflict with each other (Step S4: negative), the control unit 175 notifies the updating determination circuit 172 of completion information relating to a branch instruction that has been read from the TAGE updating buffer 174 (Step S6).

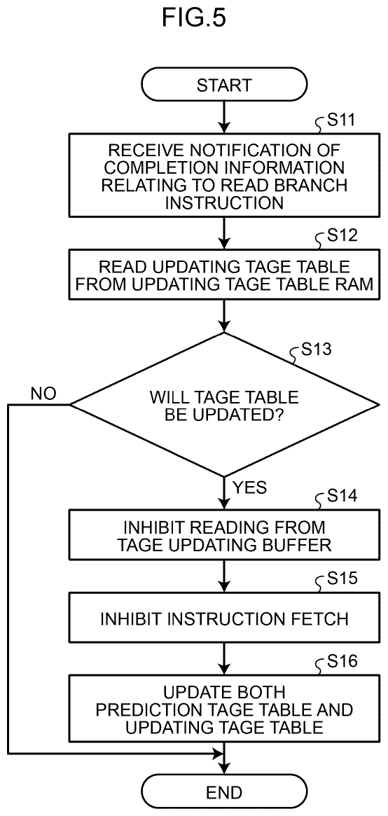

FIG. 5 is a flowchart of TAGE table updating processing. Next, a flow of TAGE table updating processing performed by the updating determination circuit 172 will be described with reference to FIG. 5.

The updating determination circuit 172 receives notification of completion information relating to a branch instruction that has been read from the TAGE updating buffer 174 by the control unit 175 (Step S11).

The updating determination circuit 172 reads the updating TAGE table from the updating TAGE table RAM 173 (Step S12).

Next, the updating determination circuit 172 determines whether the TAGE table will be updated, by using information of the updating TAGE table and the completion information relating to the branch instruction (Step S13). In a case where the TAGE table will not be updated (Step S13: negative), the updating determination circuit 172 terminates the TAGE table updating processing.

In contrast, in a case where the TAGE table will be updated (Step S13: positive), the updating determination circuit 172 inhibits the control unit 175 from reading a branch instruction from the TAGE updating buffer 174 (Step S14).

Next, the updating determination circuit 172 inhibits the instruction fetch address generator 101 to perform instruction fetch (Step S15).

Then, the updating determination circuit 172 updates both the prediction TAGE table and the updating TAGE table (Step S16).

As described above, in the CPU 10 according to the present embodiment, the prediction TAGE table RAM 171 is disposed near the instruction fetch mechanism, and the updating TAGE table RAM 173 is disposed near a mechanism that completes a branch instruction. In a case where reading from and writing to the updating TAGE table RAM 173 that are performed by the updating determination circuit 172 conflict with each other, the CPU 10 gives priority to writing. Moreover, in updating the updating TAGE table, the updating determination circuit 172 inhibits reading from the TAGE updating buffer 174. Furthermore, in updating the prediction TAGE table, the updating determination circuit 172 inhibits instruction fetch, and gives priority to writing to the prediction TAGE table RAM 171 by updating the TAGE table.

By doing this, reading is separately performed on the prediction TAGE table RAM 141 and the updating TAGE table RAM 173 in a single system, and both the prediction TAGE table RAM 141 and the updating TAGE table RAM 173 do not necessarily need to deal with reading in two systems. Furthermore, in both the prediction TAGE table RAM 141 and the updating TAGE table RAM 173, reading and writing are not simultaneously performed. Accordingly, a RAM that deals with 1-read 1-write but does not deal with simultaneous read/write can be used for both the prediction TAGE table RAM 171 and the updating TAGE table RAM 173. Accordingly, the scale of a circuit can be reduced by reducing the area of a RAM, and a length of wiring can be reduced in prediction. This enables a reduction in latency of prediction.

In one aspect of the present invention, the latency of branch prediction can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
a pipeline in which an instruction is fetched and executed;
a branch instruction processing unit that determines whether a branch has been taken in response to a predetermined branch instruction in execution of the instruction in the pipeline, detects a branch misprediction, and completes the predetermined branch instruction;
a first storage that stores a first table, information relating to a branch instruction being registered in the first table, the first table being used in branch prediction for fetch;
a second storage that stores a second table, information relating to the branch instruction that is similar to the information of the first table being registered in the second table; and
an updating determination circuit that, in a case where writing for updating is not being performed on the second table, receives, from the branch instruction processing unit, notification of completion information relating to the predetermined branch instruction, acquires information relating to the predetermined branch instruction from the second table, determines whether the updating will be performed, and updates the first table and the second table in a case where it has been determined that the updating will be performed.

2. The processor according to claim 1, further including a controller that performs
receiving the notification of the predetermined branch instruction from the branch instruction processing unit, and storing the completion information relating to the predetermined branch instruction in a temporary storage,
reading the completion information relating to the predetermined branch instruction from the temporary storage,
determining whether the writing for the updating is being performed on the second table, and
notifying the updating determination circuit of the completion information relating to the predetermined branch instruction, in a case where the writing for the updating is not being performed on the second table.

3. The processor according to claim 2, wherein, in a case where it has been determined that the updating will be performed, the updating determination circuit inhibits the controller from reading the information from the temporary storage.

4. The processor according to claim 1, wherein
the first storage is disposed near an instruction fetch mechanism included in the pipeline, and
the second storage is disposed near the branch instruction processing unit.

5. An information processing apparatus comprising:
a processor and a memory, wherein
the processor includes:
a pipeline in which an instruction is fetched and executed;
a branch instruction processing unit that determines whether a branch has been taken in response to a predetermined branch instruction in execution of the instruction in the pipeline, detects a branch misprediction, and completes the predetermined branch instruction;
a first storage that stores a first table, information relating to a branch instruction being registered in the first table, the first table being used in branch prediction for fetch;
a second storage that stores a second table, information relating to the branch instruction that is similar to the information of the first table being registered in the second table; and
an updating determination circuit that, in a case where writing for updating is not being performed on the second table, receives, from the branch instruction processing unit, notification of completion information relating to the predetermined branch instruction, acquires information relating to the predetermined branch instruction from the second table, determines whether the updating will be performed, and updates the first table and the second table in a case where it has been determined that the updating will be performed.

6. A method for controlling a processor comprising:
a pipeline in which an instruction is fetched and executed;
a branch instruction processing unit that determines whether a branch has been taken in response to a predetermined branch instruction in execution of the instruction in the pipeline, detects a branch misprediction, and completes the predetermined branch instruction; and
a first storage and a second storage,
the processor performing processing including:
in a case where writing for updating is not being performed on a second table, receiving notification of completion information relating to the predetermined branch instruction, acquiring information relating to the predetermined branch instruction from the second table, and determining whether the updating will be performed, the second table being stored in the second storage, information relating to a branch instruction being registered in the second table; and
in a case where it has been determined that the updating will be performed, updating a first table and the second table, the first table being stored in the first storage, information relating to the branch instruction that is similar to the information of the second table being registered in the first table, the first table being used in branch prediction for fetch.
